(19) United States
(12) Patent Application Publication
(10) Pub. No.: US 2025/0158058 A1
(43) Pub. Date: May 15, 2025

(54) BATTERY

(71) Applicant: TOYOTA JIDOSHA KABUSHIKI KAISHA, Toyota-shi (JP)

(72) Inventor: Yuusuke SHIMIZU, Chiryu-Shi (JP)

(73) Assignee: TOYOTA JIDOSHA KABUSHIKI KAISHA, Toyota-shi (JP)

(21) Appl. No.: 18/934,664

(22) Filed: Nov. 1, 2024

(30) Foreign Application Priority Data
Nov. 13, 2023 (JP) 2023-193192

(51) Int. Cl. H01M 4/583; H01M 4/02; H01M 4/131; H01M 4/133; H01M 4/525

(52) U.S. Cl. CPC H01M 4/583; H01M 4/131; H01M 4/133; H01M 4/525; H01M 2004/021; H01M 2004/027; H01M 2004/028

(57) ABSTRACT

A battery comprising: a cathode; an electrode body including an anode, a cathode, and a separator disposed between the cathode and the anode; and an electrolytic solution, wherein the cathode includes a cathode composite material layer including a cathode active material and a cathode current collector, the anode includes an anode composite material layer including an anode active material and an anode current collector, the cathode active material includes nickel as a transition metal, a ratio of nickel is 70 mol % or more of the entire transition metal, the anode active material includes graphite, a thickness of the anode composite material layer is 150 μm or more, and a constraint pressure is 300 kPa or less.

### CROSS-REFERENCE TO RELATED APPLICATION

This application claims priority to Japanese Patent Application No. 2023-193192 filed on Nov. 13, 2023, incorporated herein by reference in its entirety.

### BACKGROUND

### 1. Technical Field

The present disclosure relates to a battery.

### 2. Description of Related Art

There is known a battery including an electrode body in which a cathode current collector, a cathode composite material layer including a cathode active material, a separator, an anode composite material layer including an anode active material, and an anode current collector, are in a state of being laminated in this order. Such a battery is generally in a state in which pressure is applied in a thickness direction of the electrode body for the purpose of suppressing volume variation of the electrode body, maintaining electron conductivity in the electrode body, and so forth.

From a perspective of increasing capacity of the battery, increasing thickness of the anode composite material layer in the electrode body (e.g., so as to be 150 μm or more) has been studied.

On the other hand, the anode composite material layer exhibits great volume variation during charging and discharging of the battery. Accordingly, when the thickness of the anode composite material layer is increased, space in which electrolytic solution in the electrode body is held is more readily compressed by expansion of the anode composite material layer, and the electrolytic solution is more readily discharged to the outside. Increase in the discharge amount of the electrolytic solution from the electrode body might cause decrease in battery performance.

As a means for suppressing an increase in the discharge amount of the electrolytic solution due to the increase in the thickness of the anode composite material layer, reducing constraining pressure of the battery is conceivable. For example, Japanese Unexamined Patent Application Publication No. 2018-125150 (JP 2018-125150 A) describes an all-solid-state battery in which the pressure applied in the thickness direction of a single cell is about 100 kPa.

### SUMMARY

The disclosure described in JP 2018-125150 A relates to an all-solid-state battery that does not use an electrolytic solution, and retention of the electrolytic solution and effects thereof on battery performance have not been studied.

An object of the present disclosure is to provide a battery capable of achieving both increase in thickness of the anode composite material layer, and maintenance of good battery performance.

Means for achieving the above object includes the following aspects.

<1> A battery includes
an electrode body including a cathode, an anode, and a separator disposed between the cathode and the anode, and an electrolytic solution, in which
the cathode includes a cathode composite material layer including a cathode active material, and a cathode current collector,
the anode includes an anode composite material layer including an anode active material, and an anode current collector,
the cathode active material contains nickel as a transition metal, in which a proportion of nickel is 70 mol % or more as to a total of transition metal,
the anode active material includes graphite,
a thickness of the anode composite material layer is 150 μm or more, and
a constraining pressure is no greater than 300 kPa.

<2> The battery according to <1>, in which a thickness of the cathode composite material layer is 80 μm or more.

<3> The battery according to <1> or <2>, in which a porosity of the anode composite material layer is 25% by volume or more.

<4> The battery according to any one of <1> to <3>, in which a thickness of the anode composite material layer is no greater than 400 μm.

<5> The battery according to any one of <1> to <4>, in which a structure of the cathode active material is a layered structure.

According to an embodiment of the present disclosure, a battery capable of achieving both increase in thickness of an anode composite material layer and maintenance of good battery performance is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a laminate included in a battery.

### DETAILED DESCRIPTION OF EMBODIMENTS

In the present disclosure, a numerical range indicated by using “-” means a range including numerical values described before and after “-” as a minimum value and a maximum value, respectively.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

In the present disclosure, the term “step” is included in the term as long as the intended purpose of the step is achieved, even if it is not clearly distinguishable from other steps as well as independent steps.

In the present disclosure, a combination of two or more preferred embodiments is a more preferred embodiment.

In the present disclosure, the amount of each component means the total amount of a plurality of substances unless otherwise specified, when a plurality of substances corresponding to each component are present.

The battery of the present disclosure includes an electrode body including a cathode, an anode, and a separator disposed between the cathode and the anode, and an electrolytic solution,
the cathode includes a cathode composite material layer including a cathode active material, and a cathode current collector,
the anode includes an anode composite material layer including an anode active material, and an anode current collector,
the cathode active material contains nickel as a transition metal, in which a proportion of nickel is 70 mol % or more as to a total of transition metal, the anode active material includes graphite,
a thickness of the anode composite material layer is 150 μm or more, and
a constraining pressure is no greater than 300 kPa.

The battery of the present disclosure exhibits good battery performance even when the thickness of the anode composite material layer is 150 μm or more. The reason for this is inferred as follows, for example. However, the present disclosure is not limited by the following inference.

The battery of the present disclosure has a 300 kPa or lower constraint and is set at a relatively lower level. Therefore, the discharge of the electrolytic solution from the anode composite material layers expanded at the time of charge is suppressed as compared with the batteries in which the restraint pressure is greater than 300 kPa. Further, as the cathode active material contained in the cathode composite material layer, a cathode active material having a relatively high nickel content is used. A cathode composite material layer containing a cathode active material having a high nickel content has a larger degree of shrinkage during charging of the battery (that is, during expansion of the anode composite material layer) than a cathode composite material layer containing a cathode active material having a low nickel content. For this reason, the compression on the anode composite material layer that occurs when the battery is charged is alleviated by the reduction in the volume of the cathode composite material layer, and the discharge of the electrolytic solution from the electrode body is suppressed.

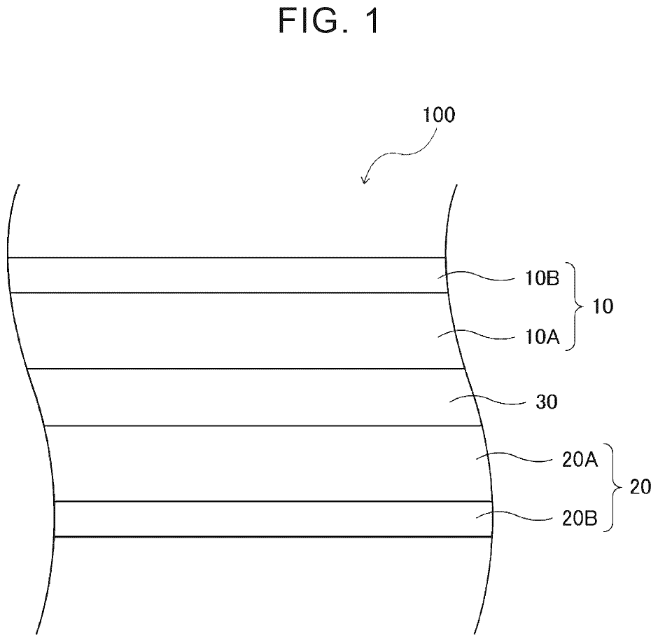

The battery of the present disclosure includes an electrode body including a cathode, an anode, and a separator disposed between the cathode and the anode. In the present disclosure, the electrode body means a structure including a laminate including a cathode, an anode, and a separator disposed between the cathode and the anode. An example of the configuration of the laminate included in the electrode body is schematically shown in FIG. 1.

The laminate 100 shown in FIG. 1 includes a cathode 10, an anode 20, and a separator 30 disposed between the cathode 10 and the anode 20. The cathode 10 includes a cathode composite material layer 10A and a cathode current collector 10B. The anode 20 includes an anode composite material layer 20A and an anode current collector 20B.

Examples of the form of the electrode body including the laminated body including the cathode, the anode, and the separator disposed between the cathode and the anode include a state in which a plurality of laminated bodies cut to a predetermined dimension are overlapped, a state in which an elongated laminated body is wound, and the like.

In the present disclosure, the restraining pressure of the battery means a pressure constantly applied in the thickness direction of the electrode body included in the battery.

The means for applying the restraining pressure to the battery is not particularly limited, and a commonly used member can be used.

The restraint pressures of the battery may be below 300 kPa and below 250 kPa, below 200 kPa, below 150 kPa, or below 100 kPa in terms of inhibiting the discharge of electrolytic solution from the electrode body.

From the viewpoint of ensuring good electronic conductivity, the restraining force of the batteries may be 10 kPa or higher, or 20 kPa or higher, or 30 kPa or higher.

The restraint pressure of the battery can be measured, for example, by measuring the reaction force when the restraint pressure is released in a state in which the battery to be measured is sandwiched between autographs.

### Cathode Composite Material Layer

The cathode active material contained in the cathode composite material layer contains nickel as a transition metal, and is not particularly limited as long as the ratio of nickel is 70 mol % or more of the total transition metal.

The proportion of nickel may be greater than or equal to 75 mol %, or greater than or equal to 80 mol % of the total transition metal. The proportion of nickel may be less than or equal to 90 mol %, or less than or equal to 85 mol % of the total transition metal.

It is more preferable that the cathode active material contains nickel as a transition metal and at least one selected from cobalt and manganese, and it is more preferable that the cathode active material contains nickel, cobalt and manganese (NCM, nickel cobalt manganese oxide).

The cathode active material may be composed only of a transition metal selected from lithium, oxygen, and Ni, Co and Mn, or may include an element other than these elements (hereinafter, also referred to as another element).

When the cathode active material contains other elements, the proportion thereof may be 10 mol % or less, 5 mol % or less, or 1 mol % or less of the entire cathode active material. When the cathode active material contains other elements, the proportion thereof may be 0.001 mol % or more, 0.01 mol % or more, or 0.1 mol % or more of the entire cathode active material.

The cathode active material is preferably a composite oxide (lithium transition metal composite oxide) containing lithium and one or more transition metals. The cathode active material preferably has a layered structure. The layered structure may be, for example, a crystal structure in which a transition metal layer formed of an octahedral structure composed of transition metal atoms and oxygen atoms and a lithium layer are alternately arranged.

The cathode active material may be a compound having a composition represented by the following formula (1).

Li₁₋ₐNiₓMe₁₋ₓO₂ (1)

In the formula (1), a satisfies the relationship of −0.3≤a≤0.3,
x satisfies the relationship of 0.7≤x≤1.0,
Me represents at least one selected from the group consisting of Co, Mn, Al, Zr, B, Mg, Fe, Cu, Zn, Sn, Na, K, Ba, Sr, Ca, W, Mo, Nb, Ti, Si, V, Cr, and Ge.

The cathode active material may be in particulate form. The average particle diameter of the cathode active material in a particulate form can be selected from, for example, a range of 5 μm to 30 μm.

In the present disclosure, the mean particle diameter of the particles is defined as the particle diameter (D50) when the cumulative volume is 50% in the volume-based particle size distribution. The volume-based particle size distribution is obtained, for example, by a laser diffraction and scattering method.

In addition to the cathode active material, the cathode composite material layer may be in a state of a mixture containing components other than the cathode active material such as a conductive auxiliary agent and a binder.

Specific examples of the conductive aid include carbon materials such as carbon black (acetylene black, thermal black, furnace black, and the like), carbon nanotubes, and graphite.

The conductive material contained in the cathode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate.

The binder contained in the cathode material may be one kind alone or two or more kinds thereof.

The cathode composite material layer may be disposed on the cathode current collector. Examples of the material constituting the cathode current collector include aluminum, an aluminum alloy, nickel, titanium, and stainless steel. Examples of the shape of the cathode current collector include a foil and a mesh.

From the viewpoint of improving the holding power of the electrolytic solution, the porosity of the cathode composite material layer is preferably 15% by volume or more, more preferably 20% by volume or more, and still more preferably 25% by volume or more.

From the viewpoint of ensuring sufficient energy density, the porosity of the anode composite material layer is preferably 40% by volume or less, more preferably 35% by volume or less, and still more preferably 30% by volume or less.

The cathode composite material layer is disposed on the cathode current collector by, for example, applying a slurry-like cathode mixture to one or both surfaces of the cathode current collector. If necessary, a pressure treatment for adjusting the density of the cathode composite material layer may be performed.

The thickness of the cathode composite material layer is not particularly limited, and can be set in consideration of, for example, a capacity ratio with respect to the anode composite material layer opposed to each other via the separator.

The thickness of the cathode composite material layer may be 80 μm or more, 90 μm or more, or 100 μm or more.

The thickness of the cathode composite material layer may be 300 μm or less, 250 μm or less, 200 μm or less, or 150 μm or less.

### Anode Composite Material Layer

The anode active material included in the anode composite material layer includes graphite.

The anode composite material layer may contain only graphite as the anode active material or may contain an anode active material other than graphite. Examples of the anode active material other than graphite include carbon materials such as hard carbon, soft carbon, and activated carbon, silicon, metallic lithium, lithium alloy, and lithium titanate (LTO). When the anode composite material layer contains an anode active material other than graphite, the proportion of graphite is preferably 70% by mass or more, more preferably 80% by mass or more, and still more preferably 90% by mass or more, of the entire anode active material.

The anode active material may be in particulate form. The average particle diameter of the anode active material in a particulate form can be selected from, for example, a range of 5 μm to 30 μm.

The anode composite material layer may be in a state of a mixture containing a component other than the anode active material such as a conductive auxiliary agent and a binder in addition to the anode active material.

The conductive material and the binder may be selected from materials that may be included in the cathode composite material layer described above.

The anode composite material layer may be disposed on the anode current collector. Examples of the material constituting the anode current collector include copper, a copper alloy, nickel, titanium, and stainless steel. Examples of the shape of the anode current collector include a foil and a mesh.

From the viewpoint of improving the holding power of the electrolytic solution, the porosity of the anode composite material layer is preferably 25% by volume or more, more preferably 30% by volume or more, and still more preferably 35% by volume or more.

From the viewpoint of ensuring sufficient energy density, the porosity of the anode composite material layer is preferably 55% by volume or less, more preferably 50% by volume or less, and still more preferably 45% by volume or less.

The anode composite material layer is disposed on the anode current collector by, for example, applying a slurry-like anode mixture to one or both surfaces of the anode current collector. If necessary, a pressure treatment for adjusting the density of the anode composite material layer may be performed.

The thickness of the anode composite material layer may be 150 μm or more, and may be 160 μm or more, 170 μm or more, or 180 μm or more.

The thickness of the anode composite material layer may be 400 μm or less, 300 μm or less, 250 μm or less, or 200 μm or less.

### Separator

The type of the separator disposed between the cathode and the anode is not particularly limited, and a known separator can be used. Specific examples of the separator include a nonwoven fabric, a cloth, and a microporous film containing a polyolefin as a main component, such as polyethylene and polypropylene.

The thickness of the separator is not particularly limited, and may be selected from, for example, a range of 5 μm to 50 μm.

### Electrolytic Solution

The battery of the present disclosure includes an electrolytic solution together with an electrode body. That is, the battery of the present disclosure is a liquid-based battery using a liquid electrolyte.

As the electrolytic solution, a solution obtained by dissolving a known electrolyte such as LiPF₆ in an organic solvent can be used without any particular limitation.

Specific examples of the organic solvents include cyclic or linear carbonates such as ethylene carbonate (EC), dimethyl carbonate (DMC), diethyl carbonate (DEC), and ethyl methyl carbonate (EMC). The solvent may be a mixture of two or more solvents or a mixture comprising a cyclic carbonate and a linear carbonate.

Solvents may include additives such as vinylene carbonate (VC).

### Form of a Battery

The form of the battery of the present disclosure is not particularly limited, and may be a known form.

In the battery of the present disclosure, the electrode body and the electrolytic solution may be accommodated in an exterior body such as a metal can or a metal film. The shape of the battery is not particularly limited, and may be a rectangular parallelepiped shape, a cylinder, or the like.

The size of the battery is not particularly limited, and can be selected according to the use of the battery.

In the battery of the present disclosure, since the discharge of the electrolytic solution from the electrode body is effectively suppressed, the battery performance is favorably maintained even when the area of the main surface of the electrode body is large (for example, from 15000 cm² to 20000 cm²) and the permeation unevenness of the electrolytic solution is likely to occur.

Hereinafter, the present disclosure will be described in more detail with reference to Examples, but the present disclosure is not limited to these Examples.

### Example 1

### (1) Preparation of Cathode

A layered lithium transition metal composite oxide (97.8 parts by mass) containing nickel (80 mol %), cobalt (10 mol %), and manganese (10 mol %) as transition metals, carbon nanotubes (0.8 parts by mass), and polyvinylidene fluoride (1.4 parts by mass) were mixed. The viscosity of the mixture was adjusted with a solvent to obtain a slurry-like cathode composite material. The cathode mixture was coated on an aluminium foil (thickness: 30 m) with a doctor blade so that the one-sided basis weight was 34 mg/cm², and dried at 100° C. for 10 minutes to form a cathode composite material layer. Thereafter, the press treatment was performed so that the density of the cathode composite material layer is 3.3 g/cm³. The thickness and porosity of the cathode composite material layer are shown in Table 1.

### (2) Preparation of the Anode

Artificial graphite particles having an average particle diameter of 22 μm (96 parts by mass), styrene-butadiene rubber (3 parts by mass), and carboxymethyl cellulose (1 part by mass) were mixed, and the viscosity was adjusted with a solvent to obtain a slurry-like anode composite material. The anode composite material is formed on a copper foil (thickness: 15 m) to have a one-sided basis weight of 23 mg/cm² (i.e., the ratio of the cathode capacity to the anode capacity is 1.1) and dried at 100° C. for 10 minutes to form an anode composite material layer. Thereafter, the press treatment was performed so that the density of the anode composite material layer is 1.25 g/cm³. The thickness and porosity of the anode composite material layer are shown in Table 1.

### (3) Preparation of Batteries

The cathode and the anode prepared in the above steps were laminated while sandwiching separators (three-layer structure of PP/PE/PP, thickness: 16 m) therebetween to prepare an electrode body. A laminated battery was manufactured using the electrode body and the electrolytic solution. As the electrolytic solution, a solution obtained by dissolving LiPF₆ of 1.1M in EC (30 volume %), DMC (40 volume %), and EMC (30 volume %) in a mixed solvent was used. The restraint pressure of the battery was adjusted to be 20 kPa.

### (4) Evaluation of Battery Performance

The activation treatment of the battery was carried out in the following procedure in a constant-current-constant-voltage manner.

Specifically, constant current charging is performed until 4.25V at the current value of 0.1 C, then constant voltage charging is performed until the time of constant voltage charging reaches 3 hours, and then discharging is performed until 3.0V at the current value of 0.1 C by the constant current method.

Charging is performed until 4.25V at the current value of 0.1 C with respect to the battery after the activation process using the constant current-constant voltage method, then discharging is performed until 3.0V at the current value of 1 C using the constant current method, and then the discharge rate (1 C discharging rate) for the theoretical rated capacity was calculated. The results are shown in Table 1.

### (5) Measurement of Resistance

The resistance of the electrode sheet was measured by the following methods using an electrode resistance measuring instrument (KNH-0622, Hioki Co.). The results are shown in Table 1.

A current is applied between two specific probes in contact with the surface of the electrode sheet to measure the potential distribution at the surface. A model of an electrode sheet composed of a composite material layer, a current collector, and an interfacial resistance therebetween is created. It is assumed that the volume resistivity of the composite material layer and the current collector and the interfacial resistance thereof are uniform. The volume resistivity and the interfacial resistance of the composite material layer at this time are set to an unknown number, and the thickness of the composite material layer, the thickness of the current collector, and the volume resistivity of the current collector are set to known values. For the modeled electrode sheet, the potential corresponding to the measured potential is obtained by solving an equation in which the potential is an unknown function by a finite volume method, and the volume resistivity and the interface resistance of the composite material layer are output.

### Examples 2 to 10, Comparative Examples 1 to 3, and Reference Examples 1 to 8

A battery having the characteristics of the cathode composite material layer, the characteristics of the anode composite material layer, and the restraint pressure of the battery shown in Table 1 was manufactured in the same manner as in Example 1, and 1 C discharging rate was measured. The results are shown in Table 1.

TABLE 1

| | | | | | | anode composite | | | | |
|---|---|---|---|---|---|---|---|---|---|---|
| | cathode composite material layer | | | | | material layer | | | Constrained | 1 C |
| | Thickness | Ni ratio | CNT | Resistance | Porosity | Thickness | Resistance | Porosity | pressure | discharging |
| | [μm] | [mol %] | [wt %] | [Ω · cm] | [Volume %] | [μm] | [Ω · cm] | [Volume %] | [kPa] | rate [%] |
| Example 1 | 103 | 80 | 0.8 | 5.7 | 25.8 | 184 | 0.2 | 42.1 | 20 | 61.1 |
| Example 2 | 103 | 80 | 0.8 | 5.7 | 25.8 | 184 | 0.2 | 42.1 | 40 | 61.5 |
| Example 3 | 103 | 80 | 0.8 | 5.7 | 25.8 | 184 | 0.2 | 42.1 | 80 | 61.8 |
| Example 4 | 103 | 80 | 0.8 | 5.7 | 25.8 | 184 | 0.2 | 42.1 | 100 | 62.0 |
| Example 5 | 103 | 80 | 0.8 | 5.7 | 25.8 | 184 | 0.2 | 42.1 | 300 | 61.3 |
| Comparative | 103 | 80 | 0.8 | 5.7 | 25.8 | 184 | 0.2 | 42.1 | 10000 | 52.5 |
| Example 1 | | | | | | | | | | |
| Example 6 | 105 | 80 | 0.3 | 71 | 27.6 | 185 | 0.5 | 42.3 | 40 | 62.0 |
| Example 7 | 105 | 80 | 0.3 | 71 | 27.6 | 185 | 0.5 | 42.3 | 80 | 62.8 |
| Example 8 | 105 | 80 | 0.3 | 71 | 27.6 | 185 | 0.5 | 42.3 | 100 | 63.0 |
| Example 9 | 105 | 80 | 0.3 | 71 | 27.6 | 185 | 0.5 | 42.3 | 300 | 62.1 |
| Comparative | 105 | 80 | 0.3 | 71 | 27.6 | 185 | 0.5 | 42.3 | 1000 | 53.0 |
| Example 2 | | | | | | | | | | |
| Example 10 | 119 | 70 | 0.8 | 7.4 | 25.8 | 184 | 0.2 | 42.1 | 80 | 60.1 |
| Comparative | 119 | 60 | 0.8 | 6.9 | 25.8 | 184 | 0.2 | 42.1 | 80 | 55.3 |
| Example 3 | | | | | | | | | | |
| Reference | 55 | 80 | 0.8 | 2.1 | 25.6 | 96 | 0.1 | 41.9 | 20 | 83.1 |
| Example 1 | | | | | | | | | | |
| Reference | 55 | 80 | 0.8 | 2.1 | 25.6 | 96 | 0.1 | 41.9 | 80 | 83.5 |
| Example 2 | | | | | | | | | | |
| Reference | 55 | 80 | 0.8 | 2.1 | 25.6 | 96 | 0.1 | 41.9 | 300 | 84.5 |
| Example 3 | | | | | | | | | | |
| Reference | 55 | 80 | 0.8 | 2.1 | 25.6 | 96 | 0.1 | 41.9 | 1000 | 84.9 |
| Example 4 | | | | | | | | | | |
| Reference | 115 | 65 | 0.8 | 6.1 | 24.4 | 184 | 0.2 | 42.1 | 20 | 54.8 |
| Example 5 | | | | | | | | | | |
| Reference | 115 | 65 | 0.8 | 6.1 | 24.4 | 184 | 0.2 | 42.1 | 80 | 55.5 |
| Example 6 | | | | | | | | | | |
| Reference | 115 | 65 | 0.8 | 6.1 | 24.4 | 184 | 0.2 | 42.1 | 300 | 55.2 |
| Example 7 | | | | | | | | | | |
| Reference | 115 | 65 | 0.8 | 6.1 | 24.4 | 184 | 0.2 | 42.1 | 1000 | 49.8 |
| Example 8 | | | | | | | | | | |

As shown in Table 1, in the batteries of Examples 1 to 5, Ni ratio of the cathode active material is 70 mol % or more, and the thickness of the anode composite material layer is 150 μm or more. The batteries of Examples 1 to 5 have higher 1 C discharging rates and excellent battery performance than the batteries of Comparative Example 1. The conditions of the batteries of Comparative Example 1 are the same conditions as those of Examples 1 to 5 except that the restraint pressure exceeds 300 kPa. Similarly, in the batteries of Examples 6 to 9, Ni ratio of the cathode active material is 70 mol % or more, the thickness of the anode composite material layers is 150 μm or more, and the restraint pressure is 300 kPa or less. The batteries of Examples 6 to 9 have a higher 1 C discharging rate and excellent battery performance than the batteries of Comparative Example 2. The conditions of the batteries of Comparative Example 2 are the same conditions as those of Examples 6 to 9 except that the restraint pressure exceeds 300 kPa.

The battery of Example 10 in which Ni ratio of the cathode active material is 70 mol % has a higher 1 C discharging rate than the battery of Comparative Example 3 under the same conditions as in Example 10 except that Ni ratio of the cathode active material is 60 mol %, and exhibits excellent battery performance.

As shown in the results of Reference Examples 1 to 4, in a battery in which the thickness of the anode composite material layer is smaller than 150 μm, the difference between the 1 C discharging rate when the restraining pressure is lower than or equal to 300 kPa and the 1 C discharge rate when the restraining pressure exceeds 300 kPa is small. As shown in the results of Reference Examples 5 to 8, in a battery in which Ni ratio of the cathode active material contained in the cathode composite material layer is less than 70 mol %, the difference between the 1 C discharging rate when the restraining pressure is lower than or equal to 300 kPa and the 1 C discharging rate when the restraining pressure exceeds 300 kPa is small.

The above results show that the improvement of the battery performance by setting Ni ratio of the cathode active material contained in the cathode composite material layer to 70 mol % or more and the constraint pressure to 300 kPa or less is remarkably exhibited when the thickness of the anode composite material layer is 150 μm or more.

What is claimed is:

1. A battery, comprising:
an electrode body including a cathode, an anode, and a separator disposed between the cathode and the anode; and an electrolytic solution, wherein
the cathode includes a cathode composite material layer including a cathode active material, and a cathode current collector,
the anode includes an anode composite material layer including an anode active material, and an anode current collector,
the cathode active material contains nickel as a transition metal, in which a proportion of nickel is 70 mol % or more as to a total of the transition metal,
the anode active material includes graphite,
a thickness of the anode composite material layer is 150 μm or more, and
a constraining pressure is no greater than 300 kPa.

2. The battery according to claim 1, wherein a thickness of the cathode composite material layer is 80 μm or more.

3. The battery according to claim 1, wherein a porosity of the anode composite material layer is 25% by volume or more.

4. The battery according to claim 1, wherein a thickness of the anode composite material layer is no greater than 400 μm.

5. The battery according to claim 1, wherein a structure of the cathode active material is a layered structure.
